(19) United States
(12) Patent Application Publication
(10) Pub. No.: US 2008/0245888 A1
(43) Pub. Date: Oct. 9, 2008

(54) Wall hanging fountain

(76) Inventors: Shiqi Zhu, Richmond, VA (US); Lincong Yang, Wenling City (CN)

Correspondence Address: JOHN S. HALE;GIPPLE & HALE, 6665-A OLD DOMINION DRIVE, MCLEAN, VA, 22101, US

(21) Appl. No.: 12/213,013

(22) Filed: Jun. 12, 2008

Related U.S. Application Data
(63) Continuation-in-part of application No. 11/901,351, filed on Sep. 17, 2007.

(30) Foreign Application Priority Data
Mar. 7, 2007 (CN) 200720107007.9

(51) Int. Cl. F21S 8/00

(52) U.S. Cl. 239/20

(57) ABSTRACT

The invention is directed toward a sealed-type fountain with infinitely variable fluid jets controlled by the user or changes in sound inputs therein. It is ideally designed for wall hanging in order to minimize the space required for its use. The wall hanging music fountain includes a frame and sealed fluid containment structure, fluid tank, controllers, and fluid pump coupled to a fluid distribution manifold. Fluid nozzles and LEDs are mounted in an aesthetically pleasing pattern onto a fluid distribution manifold mounted in proximity to the base of the fluid containment structure, and coupled to the controllers and fluid pump. When activated by the user, variations in sound from an integrated audio playback device cause aesthetically pleasing changes in the patterns of fluid nozzle and LED activation in the device.

### RELATED APPLICATIONS

This application is a continuation in part of application Ser. No. 11/901,351, filed Sep. 17, 2007, claiming priority to Chinese Patent Application No. 200720107007.9, filed on Mar. 7, 2007. U.S. application Ser. No. 11/901,351 and Chinese Patent Application No. 200720 I 07007.9 are incorporated herein by reference.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention relates to a fountain device, more particularly to a kind of wall-hanging fountain for indoor decoration and appreciation.

2. Background of the Invention

This early part of the 21^{st} century has been a particularly remarkable time in history. We are in the midst of a technological revolution and each succeeding week brings with it increasingly sophisticated devices that permit us to be ever-more productive. However, while advances in technology have in many respects made our lives easier, the availability of so much information and the ability to work twenty-four hours per day has also resulted in an unprecedented degree of stress experienced by an exponentially growing number of persons.

Reducing this stress has become an industry in and of itself. Spas have become prevalent and various devices are now available to massage or otherwise reduce that stress.

Portable tabletop and sometimes larger water fountains have become popular, both for their aesthetically pleasing design as well as their soothing and calming effect. Typically, a small pump in these devices pumps water under low pressure to the top of a three dimensional rendering of a geological feature, whereby the water is released and “trickles” to the base of the device. Once at the base, the water collects in a reservoir feeding the inlet side of the pump such that the water is continuously recycled from the base of the unit to its top. A musical playback device may be incorporated to further enhance the experience.

While these mini-fountains provide a visually attractive and soothing environment for the user, they are limited by the generally open nature of the devices. Water cannot be expelled with any appreciable force from the pump because the water is splashed outside the confines of the device. Hence, the aesthetic nature of these devices is generally limited to watching water trickle down its sides.

What is needed is a more versatile, yet equally aesthetically pleasing device. The pressure of the water expelled in such a device would be controllable between the “trickle” of currently known inventions and a more forceful jet. Moreover, expulsion of liquid would be controlled by the accompanying music, or in another embodiment, the expulsion of liquid would correspond to variations in sounds or tones received by the device.

### SUMMARY OF THE INVENTION

Accordingly, the present invention provides a sealed-type wall hanging fountain with infinitely variable fluid jets controlled by the user or by changes in sound inputs. The wall hanging music fountain comprises a frame and sealed fluid containment structure, fluid tank, controllers, and fluid pump coupled to a fluid distribution manifold. The fluid containment structure is mounted atop the fluid tank and is a substantially watertight display space including sidewalls, a rear wall on which a visually appealing rear image is applied, and a transparent front wall through which the display may be viewed. Fluid nozzles and LEDs are mounted in an aesthetically pleasing pattern onto a fluid distribution manifold positioned adjacent to the base of the fluid containment structure, and coupled to the controllers and fluid pump. Varying acoustic inputs cause corresponding, aesthetically pleasing changes in the amplitude of fluid expelled from the fluid nozzles and/or the activation patterns of the LEDs.

It is an object of this invention to provide an aesthetically pleasing kinetic art object.

Moreover, it is another object of this invention to provide a kinetic art object with infitely variable fluid flow control.

It is yet another object of this invention to provide an unobtrusive kinetic object that is wall mountable.

It is another object of this invention to create a sealed, self contained kinetic art object utilizing a liquid component.

It is still another object of this invention to provide a kinetic art object with light sources and fluid jets activated in an aesthetically pleasing manner.

It is an object of this invention to provide a user controllable kinetic art object.

### BRIEF DESCRIPTION OF THE DRAWINGS

FIG. 1 is a front elevation view of the inventive fountain device;

FIG. 2 is a rear elevation view of the embodiment shown in FIG. 1;

FIG. 3 is front elevation view of the embodiment shown in FIGS. 1 and 2 with its decorative bezel removed;

FIG. 4 is a top plan view of the embodiment of FIG. 1 with top cover removed;

FIG. 5 is a detailed perspective view showing the relative mounting positions of the fluid nozzles and LEDs;

FIG. 6 is a cutaway view of the embodiment shown in FIG. 3;

FIG. 7 is a front elevation view of an alternate embodiment of the inventive fountain device;

FIG. 8 is a front elevation view of an alternate embodiment of the inventive fountain device; and,

FIG. 9 is a front elevation view of an alternate embodiment of the inventive fountain device.

### DESCRIPTION OF THE INVENTION

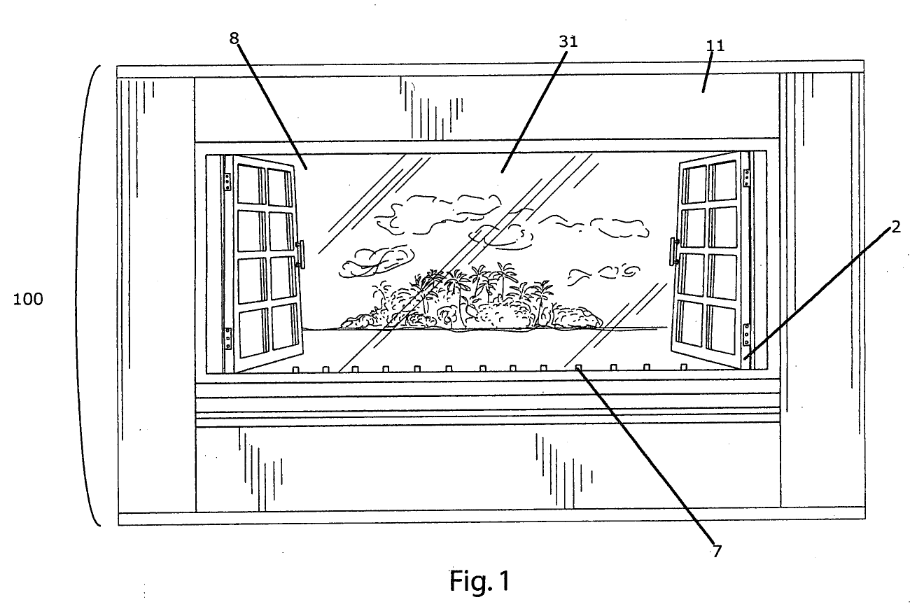

The preferred embodiments and best modes of the invention are shown in FIGS. 1 through 6. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The invention may be constructed from any moldable or formable material, but in a preferred embodiment, is constructed primarily from plastic, including but not limited to various nylon formulations, polyvinyl chloride, polyethylene, polyfluoroethylene, polypropylene, polymethyl methacrylate, and other acrylics, silicones, polyurethanes, or their composites. This device may also be manufactured from metal or metal alloy formulations. If desired, its bezel may be constructed from wood. Its transparent front wall may be manufactured from plastic, glass or similar silicate material.

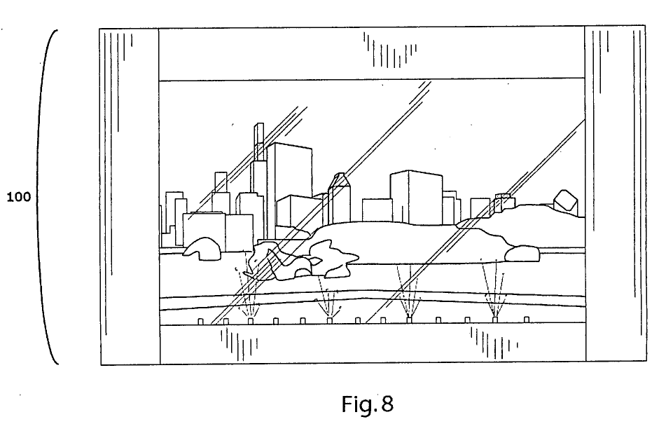

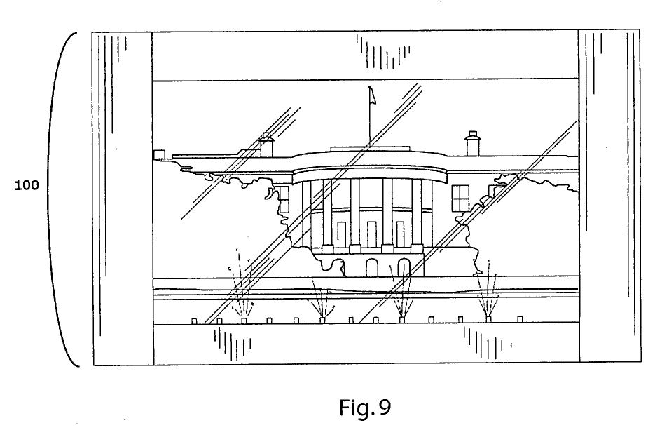

FIG. 1 is an elevation view of the assembled wall fountain apparatus 100. Visible structures include a decorative bezel 11 framing the entire apparatus and the fluid containment structure 30 for the fluid features of the invention. Elements of the fluid containment structure 30 visible in this view include a first decorative image 8 applied to a rear wall, a transparent front wall 31, and a second decorative image 2 which in this case is a perspective rendering simulating open French doors. Fluid nozzles 7 are visible in the lower sector of the transparent front wall 31. The lower portion of the second decorative image 2 conceals the LEDs 6 (see FIG. 5) and fluid distribution manifold 5 (see FIG. 5). Additional combinations of first and second decorative images 8, 2 are shown in FIGS. 7, 8, and 9, and include but are not limited to depictions of the U.S. Capital Building, the White House, and Paris' Arc de Triomphe. Other decorative images can incorporate various monuments, well known edifices, cityscapes, nightscapes, seascapes, landscapes, or various garden tableu.

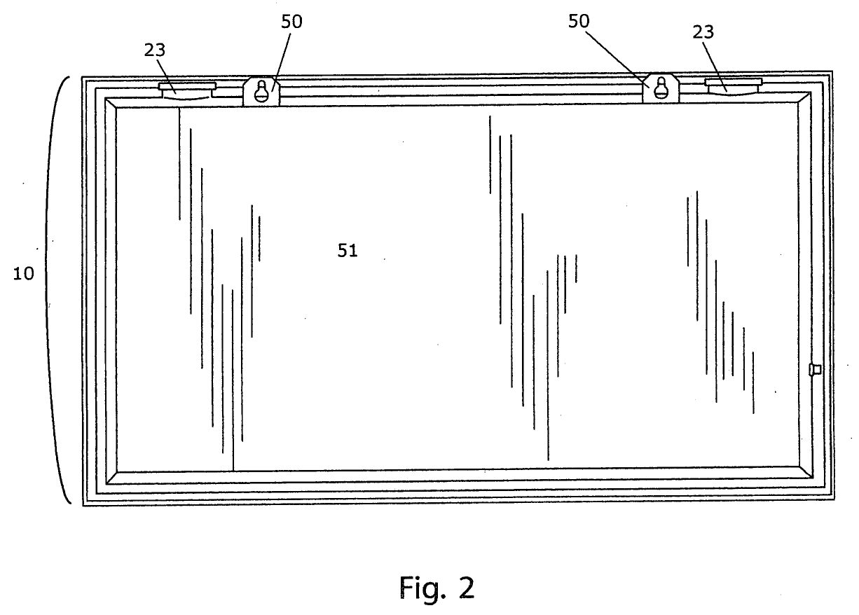

FIG. 2 discloses the rear of the assembled apparatus 100 showing rear wall 51 and hang tabs 50.

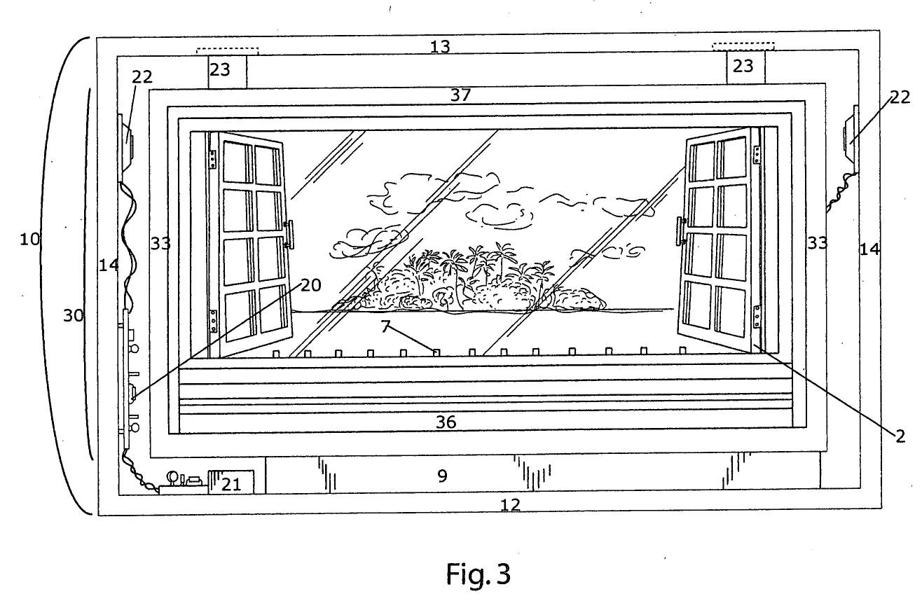

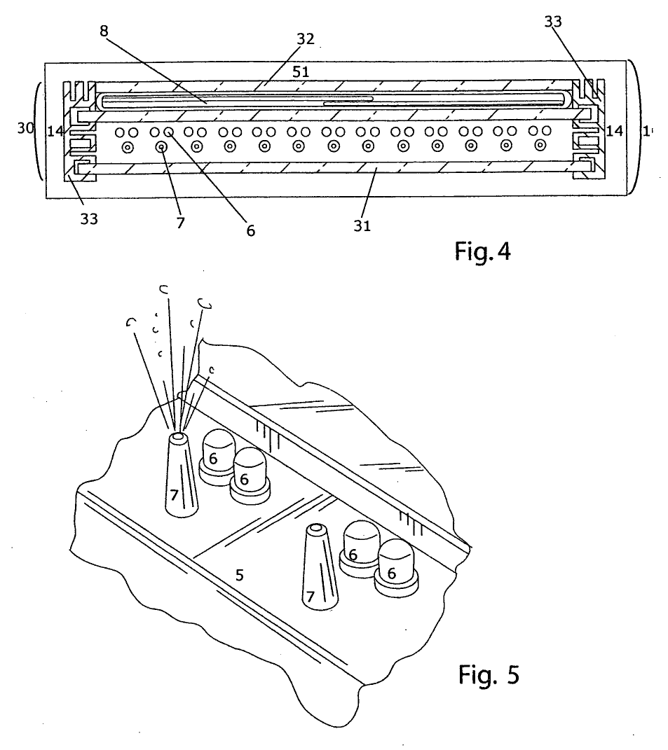

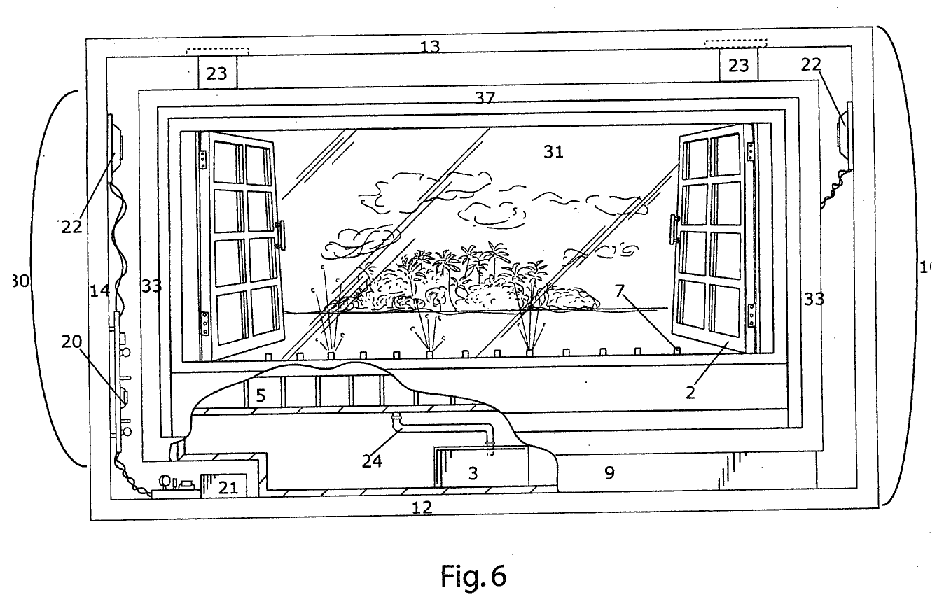

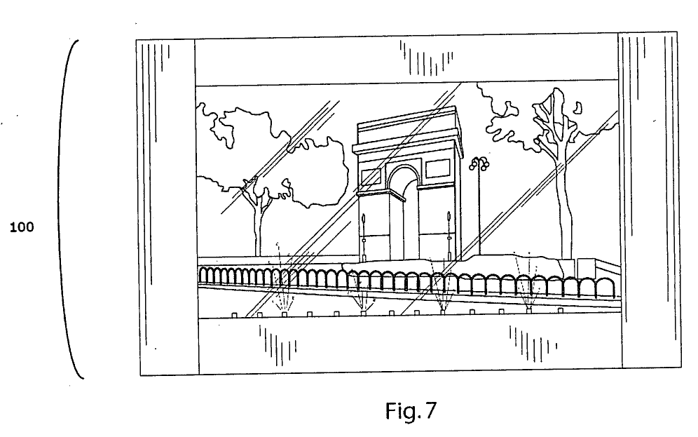

Referring now to FIG. 3, the wall fountain 100 is shown with its bezel 11 removed. The invention's fluid containment structure 30 is depicted, including its base 36, cover 37, transparent front wall 31, rear wall 32 (see FIG. 4), and sidewalls 33 defining the display space of the invention. A fluid tank 9 is mounted at the base 36 of the fluid containment structure 30 and is in fluid communication with a fluid pump 3 (see FIG. 6). Also shown in FIG. 3 is the frame 10 within which the fluid containment structure 30 and fluid tank 9 are mounted. Elements the frame include a frame base 12, frame topwall 13, and frame sidewalls 14. Also visible are two filling orifices 23 through which the fluid containment structure 30 may be filled with water or other appropriate liquid. Speakers 22 are mounted to either frame sidewall 14 and electrically connected to an audio playback device 20 mounted to the frame sidewall 14. A combination pump and light source controller 21 is mounted to the base and electrically connected to the LEDs 7 (i.e., light sources) and fluid pump 3 of the device and via which the display of LEDs 7 and fluid jets (not shown) is modulated.

Turning now to FIG. 6, the fluid pump 3 of the instant invention is submersible and mounted within the reservoir of the fluid tank 9. However, the fluid pump 3 need not be submersible and may instead be mounted in any available space within the frame 10 so long as it remains in fluid communication with the liquid in the fluid tank 9 and the fluid nozzles 7 (see FIG. 4). This cutaway view of FIG. 4 depicts the contiguous nature of the reservoir of the fluid tank 9 and the display space defined by the fluid containment structure 30. Also shown is the connecting hose 24 interconnecting the fluid pump 3 and fluid distribution manifold 5. As depicted, the fluid distribution manifold 5 is mounted in proximity to the junction between the fluid tank 9 and fluid containment structure 30. Positioning of the fluid distribution manifold 5 at points other than the vicinity of this juncture (i.e., betwixt fluid tank 9 and fluid containment structure 30) is possible, resulting in an equally aesthetically pleasing effect, so long as the invention's second decorative image 2 is positioned in a manner that masks the aforementioned operational structures. In this preferred embodiment, the fluid distribution manifold 5 is essentially a sealed, hollow, rod-shaped structure mounted essentially parallel to the frame base 12 and fluid containment structure base 36. Pressurized fluid from the fluid pump 3 is substantially evenly distributed via its hollow interior to apertures formed therein (not shown, see fluid nozzles 7 in FIG. 5).

A perspective view of the fluid distribution manifold 5 is shown in FIG. 5. A top plan view of the entire apparatus 100 is shown in FIG. 4. Both depictions advantageously show the positioning of LEDs 6 and fluid nozzles 7 of the preferred embodiment mounted to the aforementioned manifold 5. As depicted herein, fluid nozzles 7 are mounted to apertures evenly spaced along the length of the fluid distribution manifold 5. Two LEDs 6 are mounted in the proximity of each fluid nozzle 7 creating individual display units. While the fluid nozzles of this preferred embodiment direct fluid in the same direction, this invention encompasses fluid nozzles 7 that can direct fluid in multiple directions and/or have differing nozzle diameters thereby varying the pressure, and therefore the distance and force, of fluid expelled therefrom. Additional embodiments utilizing fewer than two or greater than two LED 6 light sources in conjunction with the fluid nozzles 7 are also within the scope of this invention. Such LEDs may be similarly or differently colored and they may be activated in any aesthetically pleasing pattern including patterns which alternate their activation or activate some or all at the same time in order to create additional color effects resulting from the combination of colored light produced therefrom.

In operation, the user of this apparatus fills the device by filling orifice 23 and thereafter mounts it to the wall via its hang tabs 50 (FIG. 2). Because the display space defined by the fluid containment structure 30 and the reservoir of the fluid tank 9 of the current embodiment are in communication, it is possible to overfill the apparatus wherein, for example, the LEDs 6 and fluid nozzles 7 of the device are submerged and therefore rendered inoperable. It is important that the user fill the assembled apparatus 100 only until the submersible fluid pump 3 of the present embodiment is submerged. Once energized, operation of the audio playback device 20 is initiated. Those skilled in the art will understand that such devices are widely and inexpensively available and include the electronic, non-magnetically encoded version used herein. Thereafter, changes in the quality of the sound from the aforementioned playback device 20 cause corresponding changes in the activation of the LEDs 6 and fluid nozzles 7 via the combination pump and light source controller 21 electrically connected thereto. Similarly, those skilled in the art will understand that microcircuitry is well known and inexpensively available that is suitable for controlling the activation of any electrically activated device, including the LEDs 6 and the fluid pump 3 of the instant invention. Fluid expelled from the fluid nozzles simply drains back into the reservoir of the fluid tank 9 whereby it is recirculated to the fluid pump 3.

In a second embodiment (not depicted), in lieu of a first decorative image 8 applied to the rear wall 32 of the fluid containment structure 30 and a second decorative image 2 applied to its transparent front wall 31, a complimentary decorative image may be used comprising the top and bottom portions of a single, aesthetically pleasing unitary image. The top portion of the aforementioned image is then applied to the rear wall 32 and the bottom portion applied to the transparent front wall 31 such that the bottom portion masks any distracting operational elements of the device which would otherwise detract from its aesthetic qualities, and when viewed by the user, both the top portion and complimentary bottom portion merge into a single unitary image.

In yet another embodiment (not depicted), multiple fluid pumps, solenoids, or servos mechanisms may be used in addition to the combination pump and light source controller 21 of the instant invention in order to individually control the fluid nozzles 7 and thereby enable the formation of additional fluid and light patterns. For example, varying the heights and/or activation of the fluid expelled from the fluid nozzles 7 can be used to simulate wave-like patterns.

In still another embodiment the combination pump and light source controller 21 of the present invention may be sensitive to ambient sounds in lieu of or in addition to its current configuration. Aesthetically pleasing patterns of light and sound may then be created by, for example, the sound of the user's voice or in coordination with music being played via devices elsewhere in the room.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A decorative object comprising:
a fluid containment structure having a base, cover, a transparent front wall, a rear wall, and sidewalls defining a display space therein;
a fluid tank defining a reservoir, said fluid tank mounted to said base;
a fluid distribution manifold mounted in the contiguous space defined by said display space and said reservoir;
a fluid pump operatively connected between said reservoir and said fluid distribution manifold;
a plurality of apertures in said fluid distribution manifold;
a plurality of light sources mounted to said fluid distribution manifold; and,
a controller operatively connected to said fluid pump and said light sources.

2. A decorative object as claimed in claim 1 wherein said fluid containment structure, said fluid tank, said fluid distribution manifold, said fluid pump, and said controller are mounted within a frame, said frame defined by a base, topwall, sidewalls, and a bezel framing said fluid containment structure transparent front wall.

3. A decorative object as claimed in claim 2 wherein said bezel is a decorative mirrored bezel.

4. A decorative object as claimed in claim 1 wherein a first decorative image is applied to said rear wall of said fluid containment structure and a second decorative image is applied to said fluid containment structure transparent front wall.

5. A decorative object as claimed in claim 4 wherein said first and second decorative images comprise pictorial representations of well-known edifices, cityscapes, seascapes, and landscapes.

6. A decorative object as claimed in claim 1 wherein said apertures are regularly spaced along the long dimension of said fluid distribution manifold and fluid nozzles mounted in said apertures direct fluid away from said apertures.

7. A decorative object as claimed in claim 1 wherein said light sources correspond with said apertures and are light emitting diodes (LEDs).

8. A decorative object as claimed in claim 1 wherein said controller comprises a user controlled audio playback device operatively coupled to a pump controller and light source controller wherein sonic changes in audio playback modulate fluid pump and light source operation.

9. A decorative object as claimed in claim 1 wherein said controller comprises a sonic waveform receiver operatively coupled to a pump controller and light source controller wherein ambient or external sound modulates fluid pump and light source operation.

10. A decorative object as claimed in claim 8 wherein said pump controller modulates at least one fluid pump and each said aperture may be operated independently.

11. A decorative wall fountain apparatus comprising:
a fluid containment structure having a base, cover, a transparent front wall, a rear wall, and sidewalls defining a display space therein;
a fluid tank defining a reservoir, said fluid tank mounted to said base wherein said display space and said reservoir are in communication with one another;
a fluid distribution manifold mounted in the contiguous space defined by said display space and said reservoir;
a fluid pump operatively connected between said reservoir and said fluid distribution manifold;
a plurality of apertures in said fluid distribution manifold;
fluid nozzles mounted to said apertures;
a plurality of light emitting diodes (LEDs) mounted to said fluid distribution manifold; and,
a controller operatively connected to said fluid pump and said LEDs.

12. An apparatus as claimed in claim 11 wherein said fluid containment structure, fluid tank, fluid distribution manifold, fluid pump, and controller are mounted within a frame, said frame defined by a base, topwall, sidewalls, and a bezel framing said fluid containment structure transparent front wall.

13. An apparatus as claimed in claim 12 wherein said bezel is a decorative mirrored bezel.

14. An apparatus as claimed in claim 11 wherein a first decorative image is applied to said rear wall of said fluid containment structure and a second decorative image is applied to said fluid containment structure transparent front wall.

15. An apparatus as claimed in claim 14 wherein said first and second decorative images are taken from a group consisting of the U.S. Capital Building, the White House, the Arc de Triomphe, other well-known edifices, a cityscape, a nightscape, a seascape, a landscape, and a garden tableu.

16. An apparatus as claimed in claim 12 wherein said fluid containment structure and said frame are generally parallelepiped.

17. An apparatus as claimed in claim 11 wherein said fluid nozzles direct fluid away from said fluid distribution manifold.

18. An apparatus as claimed in claim 11 wherein said controller comprises a user controlled audio playback device operatively coupled to a pump controller and LED controller wherein sonic changes in audio playback modulate fluid pump and LED operation.

19. An apparatus as claimed in claim 11 wherein said controller comprises a sonic waveform receiver operatively coupled to a pump controller and LED controller wherein ambient or external sound modulates fluid pump and LED operation.

20. An apparatus as claimed in claim 18 wherein said pump controller modulates at least one fluid pump and each said aperture may be operated independently.

21. A fountain apparatus comprising:
a generally parallelepiped fluid containment structure having a base, cover, a transparent front wall, a rear wall, and sidewalls defining a display space therein;
a fluid tank defining a reservoir, said fluid tank mounted to said base wherein said display space and said reservoir are in communication with one another;
a fluid distribution manifold mounted in the contiguous space defined by said display space and said reservoir;
a fluid pump operatively connected between said reservoir and said fluid distribution manifold;
a plurality of apertures in said fluid distribution manifold;
fluid nozzles mounted to said apertures;
a plurality of light emitting diodes (LEDs) mounted to said fluid distribution manifold;
a user controlled audio playback device operatively coupled to a pump controller and LED controller wherein sonic changes in audio playback modulate fluid pump and LED operation; and,
said generally parallelepiped fluid containment structure, said fluid tank, said fluid distribution manifold, said fluid pump, said user controlled audio playback device, said pump controller, and said LED controller mounted within a generally parallelepiped frame defined by a base, topwall, sidewalls, and a bezel framing said fluid containment structure transparent front wall.
